(19) United States
(12) Patent Application Publication
(10) Pub. No.: US 2026/0298177 A1
(43) Pub. Date: Oct. 1, 2026

(54) THRUST REVERSAL SYSTEM FOR AN AIRCRAFT, AND ASSOCIATED INSTALLATION AND AIRCRAFT

(71) Applicant: SAFRAN NACELLES, Gonfreville-L'Orcher (FR)

(72) Inventors: Vincent Jean-Francois PEYRON, Moissy-Cramayel (FR); Jihane BELLAHBIB, Moissy-Cramayel (FR); Hakim MAALIOUNE, Moissy-Cramayel (FR)

(21) Appl. No.: 19/477,675

(22) PCT Filed: Apr. 25, 2024
(86) PCT No.: PCT/FR2024/050542

§ 371 Date: Oct. 22, 2025

(30) Foreign Application Priority Data
Apr. 27, 2023 (FR) FR2304285

(51) Int. Cl. F02K 1/76; B64D 29/06; B64D 31/02; B64F 5/60

(52) U.S. Cl. CPC F02K 1/76; B64D 29/06; B64D 31/02; B64F 5/60

(57) ABSTRACT

A system includes a local control module including an analogue input port and an analogue wired connection, referred to as control connection, between a global control module and the analogue input. The local control module is designed to receive, via the control connection and the analogue input, movement commands from the global control module in order to control an electric actuator so as to move a cover. The local control module furthermore includes a transmission digital output that is separate from the analogue input, the local control module being designed to transmit operating information from the thrust reversal system via the digital output.

The present invention relates to a thrust reversal system for an aircraft, an installation comprising such a system, and an aircraft comprising such a system or such an installation.

The A380 aircraft and the C919 aircraft each comprise a thrust reversal system. Such a system comprises a thrust reversal cowl designed to be selectively moved between a stowed position to leave the thrust of a turbomachine of the aircraft unchanged and a deployed position to reverse the thrust of the turbomachine. The cowl is moved by an electric actuator for actuating the cowl. To receive the commands, a local control module is provided, connected to a global control module by a connection designed to convey at least one analogue signal.

The global control module is generally referred to by the acronym EEC (Engine Electronic Control), while the local control module is generally referred to by the acronym ETRAC (Electrical Thrust Reverser Actuation Controller). Furthermore, in these aircrafts, the connection between the EEC global control module and the ETRAC local control module is a digital bus, in particular in accordance with the ARINC 429 standard. This connection is used to transmit the commands to the ETRAC local control module and to send operating information back from the local control module to the EEC global control module.

According to this standard, the data exchanged is encoded in the form of 32-bit words divided into several distinct fields.

Still according to this standard, the digital bus comprises a pair of twisted strands and the bits are sequentially transmitted in the form of an analogue voltage signal between the two strands taking, for each bit, a high value when the bit is 1 and a low value when the bit is 0.

Implementing this standard therefore involves providing complex components both in the EEC global control module for encoding the commands in the form of 32-bit words and in the ETRAS local control module for decoding the 32-bit words received and deducing the commands from them.

To solve this problem, the French patent application published under the number FR 3 115 078 A1 describes a thrust reversal system for an aircraft, comprising:
a thrust reversal cowl designed to be selectively moved between a stowed position to leave the thrust of a turbomachine of the aircraft unchanged and a deployed position to reverse the thrust of the turbomachine:
an electric actuator for actuating the cowl;
a local control module designed to receive commands from a global control module so as to control the electric actuator in such a way so as to move the cowl, these commands including:
   a stow command to move the cowl to its stowed position, and
   a deploy command to move the cowl to its deployed position; and
a connection, referred to as control connection, between the global control module and the local control module for conveying at least one analogue signal; the local control module is designed to receive your commands in:
identifying one of a number of predefined ranges of values wherein each analogue signal lies at a given time, each command being associated with one or more of the ranges of values; and
determining the command received as being associated with the value range or ranges identified.

However, the French patent application published under the number FR 3 115 078 A1 does not address the problem of feedback of operating information.

It may therefore be desirable to provide a thrust reversal system which avoids at least some of the above-mentioned problems and constraints.

A thrust reversal system for an aircraft is therefore proposed, comprising;
a thrust reversal cowl designed to be selectively moved between a stowed position to leave the thrust of a turbomachine of the aircraft unchanged and a deployed position to reverse the thrust of the turbomachine;
an electric actuator for actuating the cowl;
a local control module comprising an analogue input port;
an analogue wired connection, referred to as control connection, between a global control module and the analogue input of the local control module; the local control module being designed to receive, via the control connection and the analogue input, movement commands from the global control module so as to control the electric actuator so as to move the cowl, these movement commands including:
a stow command to move the cowl to its stowed position, and
a deploy command to move the cowl to its deployed position; and the system being characterized in that the local control module further comprises a transmission digital output, distinct from the analogue input, the local control module being designed to transmit operating information of the thrust reversal system via the digital output.

Thanks to the invention, it is possible to recover the operating information in order, for example, to facilitate the maintenance operations,

Optionally, which local control module is designed to transmit the operating information via the transmission digital output, implementing one or more of the following digital communication protocols: CAN, and/or RS, and/or SPI, and/or serial.

Also optionally, the local control module comprises a microprocessor equipped with a first software unit for receiving the movement commands, and a second software unit, separate from the first software unit, for transmitting the operating information.

Also optionally, the microprocessor comprises a first partition for the first software unit and a second partition for the second software unit.

Also optionally, the microprocessor is also equipped with a single core housing the first and second software units.

Also optionally, the microprocessor is also equipped with two distinct cores respectively housing the first software unit and the second software unit.

Also optionally, the operating information comprises at least one of: a number of starts of the local control module, an operating time of the local control module, a state in which the thrust reversal system lies, a history of commands received, a position of an electric motor of the actuator, a speed of the electric motor, a torque of the electric motor, a fault message.

Also optionally, the local control module is designed to receive the movement commands by: identifying one of a plurality of predefined ranges of values wherein each analogue signal lies at a given instant, each command being associated with one or more of the ranges of values; and—determining the command received as being associated with the range of values identified.

An installation for an aircraft is also proposed, comprising:
a thrust reversal system according to the invention;
a system for receiving operating information; and
a digital connection between the transmission digital output and the reception system.

Also optionally, the reception system is designed to record the operating information, in particular during one or more flights of the aircraft.

Also optionally, the reception system comprises an output port designed to be connected to a mobile maintenance equipment, the collection system being designed to provide the recorded operating information to the mobile maintenance equipment via the output port.

Also optionally, the reception system comprises a wireless communication interface with a ground reception system, the wireless communication interface being for example one of: a WIFI interface, a 3G, 4G or 5G interface, the reception system being designed to provide the operating information recorded to the reception system by this wireless communication interface.

An aircraft is also proposed comprising:
a turbomachine; and
a thrust reversal system according to the invention or an installation according to the invention.

The invention will be better understood with the aid of the following description, given solely by way of example and made with reference to the appended drawings wherein:

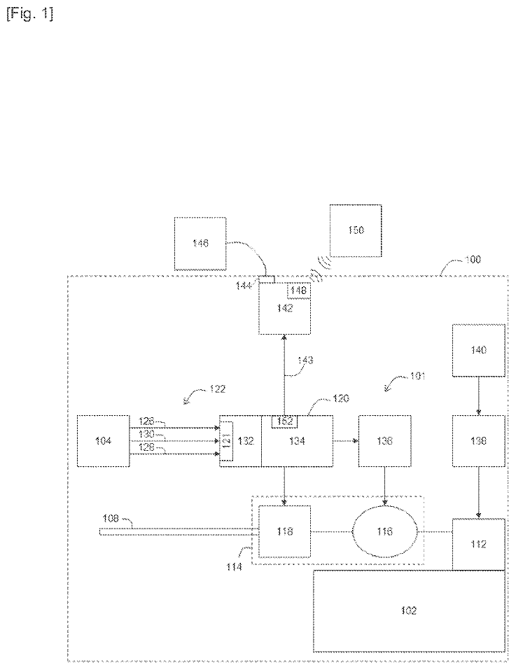

FIG. 1 is a simplified view of an aircraft comprising a thrust reversal system according to a first embodiment of the invention,

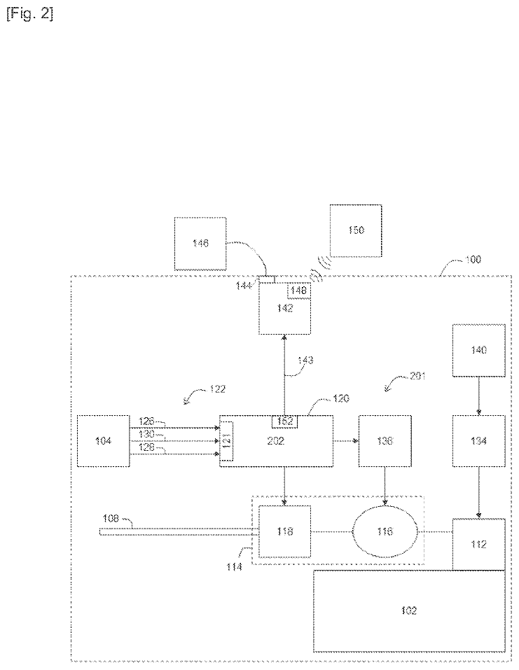

FIG. 2 is a simplified view of an aircraft comprising a thrust reversal system according to a second embodiment of the invention,

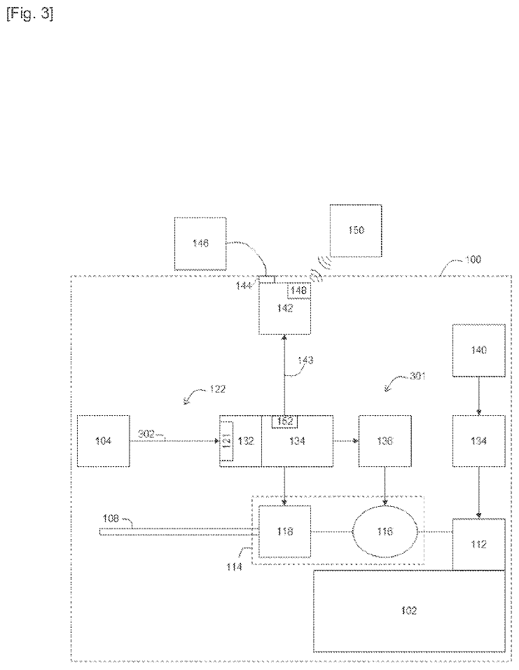

FIG. 3 is a simplified view of an aircraft comprising a thrust reversal system according to a third embodiment of the invention,

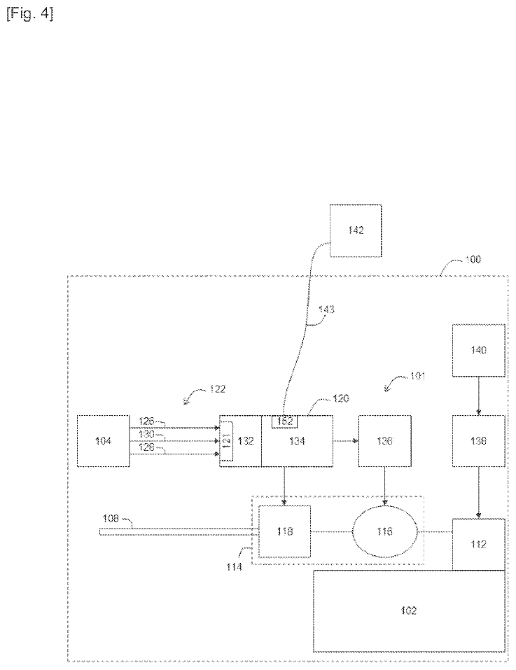

FIG. 4 is a simplified view of an aircraft comprising a thrust reversal system according to a fourth embodiment of the invention, and

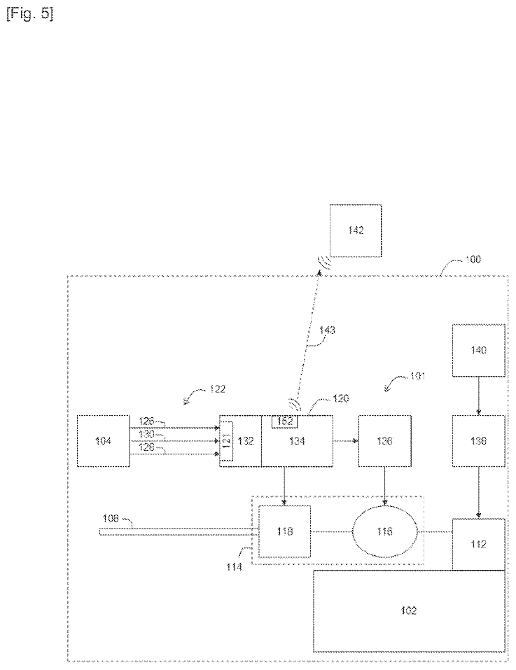

FIG. 5 is a simplified view of an aircraft comprising a thrust reversal system according to a fifth embodiment of the invention.

With reference to FIG. 1, an aircraft 100 comprising a thrust reversal system 101 according to a first embodiment of the invention will now be described.

The aircraft 100 firstly comprises a turbomachine 102.

The aircraft 100 also comprises an overall control module 104, the latter comprises at least one computer. Preferably, the global control module 104 comprises two redundant computers. The global control module 104 may, for example, be an EEC or an EIF (Engine Interface Function).

The aircraft 100 also comprises a DC voltage bus 108.

The thrust reversal system 101 firstly comprises a thrust reversal cowl 112 designed to be selectively moved between a stowed position to leave the thrust of the turbomachine 102 unchanged and a deployed position to reverse the thrust of the turbomachine 102. The thrust reverser is, for example, a gate thrust reverser or a grid thrust reverser.

The system 101 also comprises an electric actuator 114 for actuating the cowl 112.

In the example described, the electric actuator 114 comprises an electric motor 116 for moving the cowl 112 and an inverter 118 designed to electrically activate the electric motor 116 from the DC voltage bus 108.

The system 101 also comprises a local control module 120, such as an ETRAC, equipped with an analogue input port 121.

The system 101 also comprises an analogue wire connection 122 between the global control module 104 and the local control module 120. This connection 122 is designed to convey at least one analogue signal from the global control module 104 and the local control module 120. This analogue signal or signals represents commands for the local control module 120. The thrust reversal system 101 is thus advantageously controlled by discrete analogue signals, which simplifies the communication between the computer of the aircraft and the system 101.

In the example described, the connection 122 comprises three electrical conductors 124, 126 and 128. The first two electrical conductors 124, 126 are configured to convey respectively two analogue voltage signals V1, V2, referenced relative to the third electrical conductor 128 forming an electrical ground.

Still in the example described, the local control module 120 comprises an analogue-to-digital converter 132 designed to convert the analogue signal or signals (the voltages V1, V2 in the example described) into digital data and a digital module 134 designed to process this digital data to determine the commands received.

The commands include in particular: a “STOW” command to move the cowl 112 to its stowed position and a “DEPLOY” command to move the cowl 112 to its deployed position.

Furthermore, in the example described, the system 101 comprises several locking devices to prevent an inadvertent deployment of the cowl 112, for example outside the landing phase of the aircraft 100.

Thus, the system 101 also comprises a so-called primary lock system 136 designed to selectively lock (e.g. by mechanical blocking) and unlock the electric motor 116 of the electric actuator 114 for actuating the thrust reversal cowl 112. In this case, the local control module 120 is designed to, upon the reception of the DEPLOY command, control the primary lock system 136 so as to unlock the electric motor 116 of the electric actuator 114 of the thrust reversal cowl 112, before the cowl 112 has been moved to its deployed position. It is further designed to, upon reception of the stow command (STOW), control the primary lock system 136 so as to lock the electric motor 116 of the electric actuator 114 of the thrust reversal cowl 112, after the cowl 112 has been moved to its stowed position.

Generally, two thrust reversal systems such as the system 101 are provided, with the cowls respectively connected to each other. In this way, the “primary” lock system of one of the systems also forms a “secondary” lock system for the other system.

The system 101 also comprises a “tertiary” lock system 138 (Tertiary Lock System) designed to selectively lock and unlock the cowl 112. In this case, the cowl 112 is preferably further designed to be selectively moved into a release position facilitating an unlocking of the cowl by the tertiary lock system 138. This disengaged position is usually an even more stowed position. The commands then further comprise a OVERSTOW command and the local control module 120 is then arranged to, on reception of the OVERSTOW command, control the primary lock system 132 so as to unlock the electric motor 116 from the electric actuator 114 for actuating the thrust reversal cowl 112, before controlling the inverter 118 so that the cowl 112 is moved into its disengaged position.

The tertiary locking device 138 is for example controlled by a control member 140, for example by a joystick provided in a cockpit of the aircraft 100, which activates the closing of a relay. However, many other control members for controlling the tertiary lock system 138 may be provided.

As previously explained, the local control module 120 is designed to receive commands from the global control module 104, via the connection 122, in order to control the electrical actuator 114, and more specifically the inverter 118 in the example described, so as to move the cowl 112.

In general, the local control module 120 is designed to identify one of several predefined ranges of values wherein each analogue signal lies at a given time, each command being associated with one or more of the ranges of values. The local control module 120 is further designed to determine the received command as the one associated with the identified value range or ranges.

More precisely, in the example described, the analogue voltage signals V1, V2 are each associated with two ranges of values. For example, one of these two ranges of values extends around zero voltage and the other range of values extends around 28 V. Each command is associated with a respective one of the predefined combinations of the value ranges of the two analogue voltage signals V1, V2. It may therefore be considered that the commands are encoded on three bits [b1 b2 b3] respectively transmitted by the three electrical conductors 126, 130, 128. The first bit b1 is transmitted by the first electrical conductor 126 and its values correspond to the two ranges of values for this first electrical conductor 126. The second bit b2 is transmitted by the third electrical conductor 130 which is not configured to transmit an analogue signal so that the second bit b2 remains at the same value, for example zero. The third bit b3 is transmitted by the second electrical conductor 128 and its values correspond to the two value ranges for this second electrical conductor 128.

In the example described, the commands are encoded by the bits [b1 b2 b3] as follows:

TABLE 1

| [b1 b2 b3] | Command |
|---|---|
| [0 0 0] | No command |
| [1 0 1] | OVERSTOW |
| [1 0 1] | DEPLOY |
| [1 0 0] | STOW |

In the example described, the OVERSTOW and DEPLOY commands have the same code. In this case, for example, upon receipt of this code, the OVERSTOW command may be performed, and then after a certain delay time (implemented for example by a delay device) the DEPLOY command may be automatically performed, without requiring the receipt of a new code. Alternatively, two different codes may be associated with the OVERSTOW and DEPLOY commands respectively, the latter being performed upon receipt of its associated code.

The local control module 120 further comprises a transmission digital output 152 via which the local control module 120 is designed to transmit information about the operation of the thrust reversal system 101. The transmission digital output 152 is separate from the analogue input port 121 and complements the latter.

The operating information comprise, for example, one or more elements among: a number of starts of the local control module 120, an operating time of the local control module 120, a state in which the thrust reversal system 101 is, a history of commands received, a position of the electric motor 116, a speed of the electric motor 116, a torque of the electric motor 116, and one or more fault messages.

The local control module 120 comprises, for example, a microprocessor equipped with a first software unit for receiving the movement commands, and a second software unit, distinct from the first software unit, for transmitting the operating information. For example, the microprocessor comprises a first partition for the first software unit and a second partition for the second software unit. For example, the microprocessor is equipped with a single core housing the first and second software units. Alternatively, the microprocessor is equipped with two separate cores housing the first software unit and the second software unit respectively.

The transmission digital output 152 may be wired and comprise a port, for example on the front panel of the local control module 120. A wire digital connection 143 connects the transmission digital output 152 to a system 142 for receiving operating information. For example, the wire digital connection 143 may be non-redundant and comprise a single connector.

The reception system 142 may be, as illustrated in FIG. 1, an element of the aircraft 100.

The reception system 142 is separate from the global control module 104 and may either be dedicated to receiving operating information from the thrust reversal system 101 or designed to receive operating information from other members of the aircraft 100. The reception system 142 may also be designed to process the information received, for example to format it or to certify the correct operation and conformity of the thrust reversal system 101, in particular the computer of the local control module 120.

The reception system 142 may comprise a non-redundant computer.

The reception system 142 is designed, for example, to record the operating information received, in particular during one or more flights of the aircraft 100. The reception system 142 is also designed, for example, to transmit the recorded operating information to the outside of the aircraft, for example when the aircraft 100 is on the ground.

For example, the reception system 142 comprises an output port 144 designed to be connected to a mobile maintenance equipment 146 brought into the aircraft on the ground. The reception system 142 is then designed to supply the recorded operating information to the mobile maintenance equipment 146 via this output port 144.

Still for example, the reception system 142 comprises a wireless communication interface 148 with a reception system 150 on the ground. The wireless communication interface 148 is for example one of: a WIFI interface, a 3G, 4G or 5G interface. The reception system 142 is then designed to provide the recorded operating information to the reception system via this wireless communication interface 148.

The local control module 120 and the reception system 142 are designed, for example, to exchange the operating information via the digital connection 143, using a digital communication protocol. Since the operating information collected is not necessarily essential for real-time control of the thrust reversal system 101, and does not necessarily have an impact on the flight safety, the communication protocol and/or the digital connection 143 and/or the collection system 142 may be simplified. For example, the communication protocol may be non-relayed (i.e. without automatic acknowledgement) and/or non-redundant, unlike the AFDX or ARINC429 type protocols generally used in the avionics systems. For example, the communication protocol may be one of: CAN (Controller Area Network), RS232, RS422, SPI (Serial Peripheral Interface), serial. The simplified communication protocols have the advantage of not requiring dedicated digital communication components and may therefore be generated directly by the digital core of the local control module 120. This allows to simplify the local control module 120 in terms of both hardware and software.

With reference to FIG. 4, the reception system 142 may be a maintenance equipment carried in the aircraft on the ground, during production or maintenance phases (in the workshop or under the wing), and absent from the aircraft during the flight phases.

In this case, the local control module 120 may be designed to record the operating information, in particular during one or more flights of the aircraft 100, so that it may be transmitted to the reception system 142 when the latter is connected, for example during production or maintenance phases (in the workshop or under the wing).

With reference to FIG. 5, the transmission digital connection 143 may be wireless. In this case, the digital output 152 may be a wireless communication interface, for example one of: a WIFI interface, a 3G, 4G or 5G interface.

With reference to FIG. 2, a thrust reversal system 201 according to a second embodiment of the invention will now be described. The system 201 is similar to that shown in FIG. 1, except that the local control module 120 comprises, instead of the analogue-to-digital converter 132 and the digital module 134, an analogue circuit 202 for deducing the commands and controlling the inverter 118 accordingly.

With reference to FIG. 3, a thrust reversal system 301 according to a third embodiment of the invention will now be described. The system 301 is similar to that of FIG. 1, except that the connection 122 comprises an electrical connector 304 conveying an analogue current signal associated with a plurality of value ranges, each command being associated with a respective one of the value ranges. Preferably, the ranges of values do not overlap in order to avoid control banding. Preferably, the ranges of values are disjoint, except possibly between the respective ranges of the OVERTOW and DEPLOY commands.

For example, the commands are coded as follows:

TABLE 2

| Current value range | Command |
|---|---|
| [value 1-value 2] | OVERSTOW |
| [value 2-value 3] | DEPLOY |
| [value 4-value 5] | STOW |

The values outside these control ranges are considered invalid.

It should also be noted that the invention is not limited to the embodiments described above. In fact, it will appear to the person skilled in the art that various modifications may be made to the above-described embodiments, in the light of the teaching just disclosed.

In the detailed presentation of the invention given above, the terms used are not to be interpreted as limiting the invention to the embodiments set forth in the present description, but are to be interpreted as including all equivalents for which it is possible for a person skilled in the art to predict by applying its general knowledge to the implementation of the teaching.

1. A thrust reversal system for an aircraft, comprising:
a thrust reversal cowl designed to be selectively moved between a stowed position to leave the thrust of a turbomachine of the aircraft unchanged and a deployed position to reverse the thrust of the turbomachine;
an electric actuator for actuating the cowl;
a local control module comprising an analogue input port;
an analogue wired connection, referred to as a control connection, between a global control module and the analogue input of the local control module;
the local control module being designed to receive, via the control connection and the analogue input, movement commands from the global control module so as to control the electric actuator so as to move the cowl, these movement commands including:
a stow command to move the cowl to its stowed position, and
a deploy command to move the cowl to its deployed position; and
the system being characterized in that the local control module further comprises a transmission digital output, distinct from the analogue input, the local control module being designed to transmit operating information of the thrust reversal system via the digital output.

2. The system according to claim 1, wherein the local control module is designed to transmit the operating information via the transmission digital output, implementing one or more of the following digital communication protocols: CAN, and/or RS, and/or SPI, and/or serial.

3. The system according to claim 1, wherein the local control module comprises a microprocessor equipped with a first software unit for receiving the movement commands, and a second software unit, separate from the first software unit, for transmitting the operating information.

4. The system according to claim 3, wherein the microprocessor comprises a first partition for the first software unit and a second partition for the second software unit.

5. The system according to claim 3, wherein the microprocessor is equipped with a single core housing the first and second software units.

6. The system according to claim 3, wherein the microprocessor is equipped with two distinct cores respectively housing the first software unit and the second software unit.

7. The system according to claim 1, wherein the operating information comprises at least one of: a number of starts of the local control module, an operating time of the local control module, a state in which the thrust reversal system lies, a history of commands received, a position of an electric motor of the actuator, a speed of the electric motor, a torque of the electric motor, a fault message.

8. The system according to claim 1, wherein the local control module is designed to receive the movement commands by:
identifying one of a plurality of predefined ranges of values wherein each analogue signal lies at a given instant, each command being associated with one or more of the ranges of values; and
determining the command received as being associated with the range of values identified.

9. An installation for an aircraft comprising:
a thrust reversal system according to claim 1;
a system for receiving operating information; and
a digital connection between the transmission digital output and the reception system.

10. The installation according to claim 9, wherein the reception system is designed to record the operating information, in particular during one or more flights of the aircraft.

11. The installation according to claim 9, wherein the reception system comprises an output port designed to be connected to a mobile maintenance equipment, the collection system being designed to provide the recorded operating information to the mobile maintenance equipment via the output port.

12. The installation according to claim 9, wherein the reception system comprises a wireless communication interface with a ground reception system, the wireless communication interface being for example one of: a WIFI interface, a 3G, 4G or 5G interface, the reception system being designed to provide the operating information recorded to the reception system by this wireless communication interface.

13. An aircraft comprising:
a turbomachine; and
a thrust reversal system according to claim 1.

14. An aircraft comprising:
a turbomachine; and
an installation according to claim 9.
